(19) United States
(12) Patent Application Publication
(10) Pub. No.: US 2026/0273631 A1
(43) Pub. Date: Sep. 17, 2026

(54) MODULAR ROTARY CUTTING TOOLS

(71) Applicant: Kennametal Inc., Latrobe, PA (US)

(72) Inventors: Ruy Frota de Souza Filho, Latrobe, PA (US); Alan J. Bookheimer, Greensburg, PA (US); Austin Baer, Latrobe, PA (US); Marcelo Euripedes da Silva, Piracicaba (BR); Berthold Zeug, Fürth (DE); Michael Schuffenhauer, Fürth (DE); Bernhard Eckl, Fürth (DE)

(21) Appl. No.: 19/670,581

(22) Filed: May 7, 2026

Related U.S. Application Data
(63) Continuation of application No. 18/120,943, filed on Mar. 13, 2023, now Pat. No. 12,708,947.

(51) Int. Cl. B23B 51/00; B23B 27/16

(52) U.S. Cl. CPC B23B 51/0007; B23B 27/1611

(57) ABSTRACT

Rotary cutting tools are disclosed comprising shanks and replaceable cutting inserts are provided. The shank comprises a pocket which receives an interchangeable cutting insert. The pocket includes a floor with a central pin-receiving hole, opposing pocket centering walls, and torque transmitting pocket drive walls. The cutting insert has a relatively long rear pin receivable in the central hole of the shank. A head of the cutting insert includes insert centering surfaces that contact the pocket centering walls of the shank, and insert drive surfaces that contact the torque transmitting pocket drive walls of the shank. The configurations and sizes of the shank and cutting insert features are controlled to provide improved torque transmission, rigidity and stability during operation of the rotary cutting tools.

### CROSS-REFERENCE TO RELATED APPLICATION

The application is a continuation of U.S. Patent Application No. 18/120,943 filed March 13, 2023, the entirety of which is incorporated by reference.

### FIELD OF THE INVENTION

The present invention relates to modular rotary cutting tools including shanks and replaceable cutting inserts.

### BACKGROUND INFORMATION

Drills with replaceable cutting tips are known. Typically, the cutting heads and shanks can display continuous and complementing configuration as fluted drills. Each shank will normally include a structure for retaining and rotating an associated cutting head, while the associated cutting head will have a complementing structure for being retained and rotated by the shank. Challenges such as deformation and failure are encountered during the service life of a drill due to a concentration of stresses imposed on the retaining and drive structure of the shank during ordinary service. This may unduly limit the useful service life of the drill.

### SUMMARY OF THE INVENTION

Rotary cutting tools comprising shanks and replaceable cutting inserts are provided. The shank comprises a pocket which receives an interchangeable cutting insert. The pocket includes a floor with a central pin-receiving hole, opposing pocket centering walls, and torque transmitting pocket drive walls. The cutting insert has a relatively long rear pin receivable in the central hole of the shank. A head of the cutting insert includes insert centering surfaces that contact the pocket centering walls of the shank, and insert drive surfaces that contact the torque transmitting pocket drive walls of the shank. The configurations and sizes of the shank and cutting insert features are controlled to provide improved torque transmission, rigidity and stability during operation of the rotary cutting tools.

An aspect of the present invention is to provide a modular rotary cutting tool comprising a shank having a central longitudinal axis and a cutting insert removably installed on the shank. The shank includes a front pocket with a central pin-receiving hole. The cutting insert includes a pin receivable in the pin-receiving hole of the shank. The front pocket includes first and second opposing pocket centering walls, first and second torque transmission pocket drive walls, and a pocket floor. The first pocket centering wall defines a plane, the first pocket drive wall defines another plane, the first pocket centering wall plane, and the first pocket drive wall plane intersect at a pocket intersection point P located at the pocket floor at a pocket wall angle A measured at the pocket intersection point P that is from greater than 90° to less than 155°, and wherein each of the first and second pocket drive walls are disposed in planes parallel with the longitudinal axis of the shank.

Another aspect of the present invention is to provide a shank of a modular rotary cutting tool having a central longitudinal axis and including a central pin-receiving hole and a front pocket. The front pocket includes first and second opposing pocket centering walls, first and second torque transmission pocket drive walls, and a pocket floor. The first pocket centering wall defines a plane, the first pocket drive wall defines another plane, and the first pocket centering wall plane and the first pocket drive wall plane intersect at a pocket intersection point P located at the pocket floor at a pocket wall angle A measured at the intersection point P that is from greater than 95° to less than 155°, and wherein each of the first and second pocket drive walls are disposed in planes parallel with the longitudinal axis of the shank.

A further aspect of the present invention is to provide a cutting insert for a modular rotary cutting tool having a central longitudinal axis and comprising a head and a pin extending rearwardly from the head. The head includes first and second insert centering surfaces, first and second torque transmission insert drive surfaces, and a rear face. The first insert centering surface defines a plane, the first insert drive surface defines another plane, and the first insert centering surface plane and the first insert drive surface plane intersect at an insert intersection point P′ located in a plane of the rear surface at an insert surface angle A′ measured at the insert intersection point P′ that is from greater than 90° to less than 155°, and wherein each of the first and second insert drive surfaces are disposed in planes parallel with the longitudinal axis of the shank.

Another aspect of the present invention is to provide a cutting insert for a modular rotary cutting tool comprising a head having a length L_{H} measured in an axial direction of the cutting insert, and a pin extending rearwardly from the head in the axial direction having a length L_{P}, wherein a pin to head length ratio L_{P}:L_{H} is greater than 1:1.

These and other aspects of the present invention will be more apparent from the following description.

### BRIEF DESCRIPTION OF THE DRAWINGS

FIGS. 1 and 2 are isometric views, FIGS. 3 and 4 are side views, FIG. 5 is a front end view, and FIGS. 6-8 are side sectional views taken through various lines of FIG. 5, of a modular rotary cutting tool of the present invention including a shank and a replaceable cutting insert.

FIG. 9 is an isometric view, FIGS. 10-12 are side views and FIG. 13 is a front end view of the rotary cutting tool shank shown in FIGS. 1-8.

FIGS. 14-16 are isometric views, FIGS. 17 and 18 are side views, FIG. 19 is a front end view and FIG. 20 is a rear end view of the cutting insert shown in FIGS. 1-8.

FIGS. 21-23 are isometric views, FIGS. 24 and 25 are side views, FIG. 26 is a front end view and FIG. 27 is a rear end view of another cutting insert of the present invention.

FIGS. 28-30 are isometric views, FIGS. 31 and 32 are side views, FIG. 33 is a front end view and FIG. 34 is a rear end view of a further cutting insert of the present invention.

FIGS. 35-37 are isometric views, FIGS. 38 and 39 are side views, FIG. 40 is a front end view and FIG. 41 is a rear end view of another cutting insert of the present invention.

FIG. 42 is a side view of a modular rotary cutting tool of the present invention including a shank and a replaceable cutting insert.

FIG. 43 is a front end view of the rotary cutting tool of FIG. 42.

FIG. 44 is a side sectional view of the rotary cutting tool taken through line 44-44 of FIG. 43.

FIGS. 45 and 46 are partial side views, and FIG. 47 is a front end view, of the rotary cutting tool shank shown in FIGS. 42-44.

FIGS. 48 and 49 are side views, and FIG. 50 is a front end view, of the cutting insert shown in FIGS. 42-44.

FIG. 51 is a side sectional view taken through line 51-51 of FIG. 50 illustrating a cutting insert and a set screw.

FIG. 52 is a rear end view of the cutting insert shown in FIGS. 42-44 and 50.

FIG. 53 is a partially schematic side view of a portion of the cutting insert shown in FIGS. 48-52 illustrating details of a pin of the cutting insert and arrangement of the set screw.

FIG. 54 is a partially schematic side view, FIG. 55 is a side sectional view taken through line 55-55 of FIG. 54, and FIG. 56 is a side sectional view taken through line 56-56 of FIG. 55, illustrating features of a bump-off tool that may be used to facilitate removal of cutting inserts from rotary cutting tool shanks in accordance with the present invention.

FIG. 57 is a partially schematic side view, FIG. 58 is a side sectional view taken through line 58-58 of FIG. 57, and FIG. 59 is a side sectional view taken through line 59-59 of FIG. 58, illustrating the bump-off tool of FIGS. 54-56 in an inserted position in the shank of the rotary cutting tool.

### DETAILED DESCRIPTION

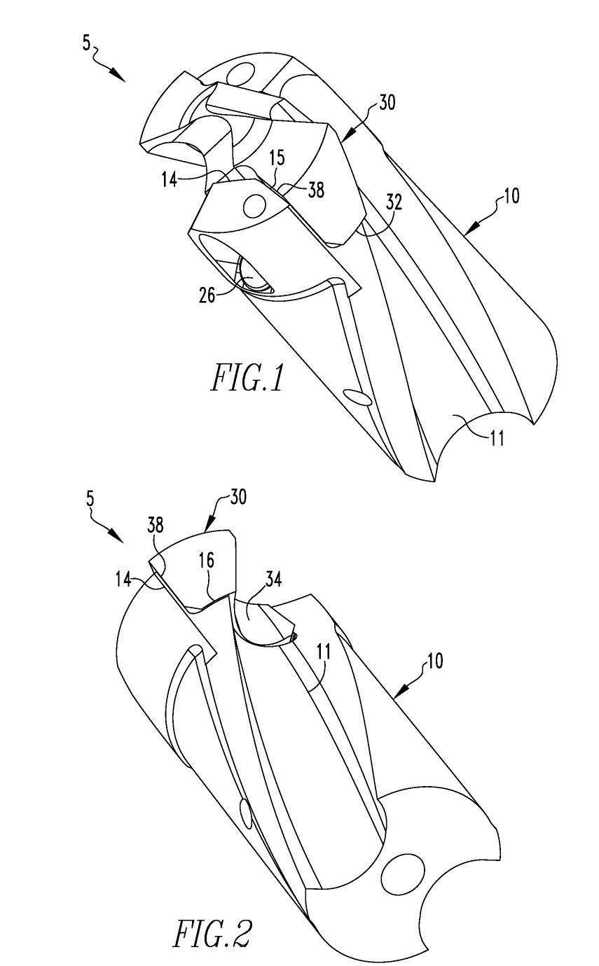

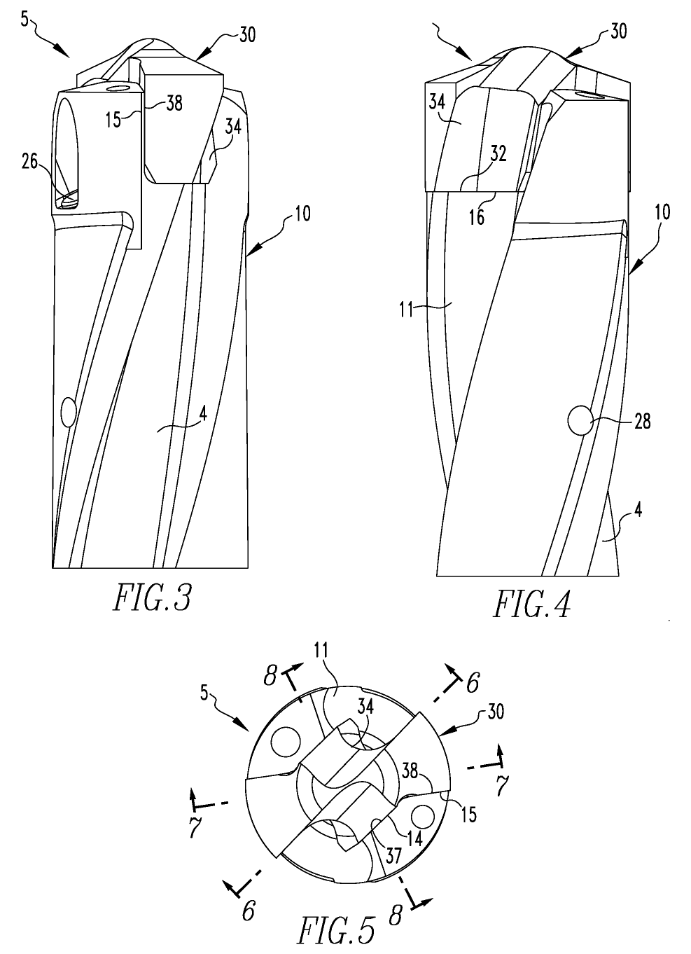

FIGS. 1-20 illustrate a modular rotary cutting tool 5 in the form of a drill having a shank 10 and a replaceable cutting insert 30. A central longitudinal axis is defined through the cutting tool 5, common to both the shank 10 and the cutting insert 30. The modular rotary cutting tools of the present invention perform rotary cutting operations on a workpiece, and may include drills, countersinking tools, milling tools, reaming tools, and the like.

The shank 10 includes a pair of flutes 11 along the sides of the shank 10 and a front pocket 12. The front pocket 12 includes opposing centering walls 14 and torque transmission drive walls 15. Each pocket drive wall 15 intersects an adjacent one of the pocket centering walls 14. A pocket floor 16 is provided at the bottom of the pocket 12. As more fully described below, each pocket centering wall 14 and adjacent pocket drive wall 15 define planes that intersect each other at the floor 16 at an intersection point P. The location of the intersection point P, as well as an intersecting pocket wall angle A of the centering and drive walls 14 and 15, are controlled to provide improved torque transmission, rigidity and stability during operation of the rotary cutting tools, as more fully described below.

As shown most clearly in the side view of FIG. 12, each pocket centering wall 14 of the pocket 12 may be slightly inclined at a seating angle S, which may typically be greater than 0°, for example, greater than 0.1° or greater, or greater than 0.5°, or greater than 1°. The seating angle S may typically be less than 5°, or less than 4°, or less than 3°. The seating angle S may typically range from 0.5 to 5°, for example, from 1 to 4°, or from 1.5 to 3.5°, or from 2 to 3°. As shown in FIG. 12, the seating angle S for each of pocket centering walls 14 may be the same. As more fully described below, the pocket drive walls 15 may be parallel with each other in planes that are parallel with the central longitudinal axis of the shank 10.

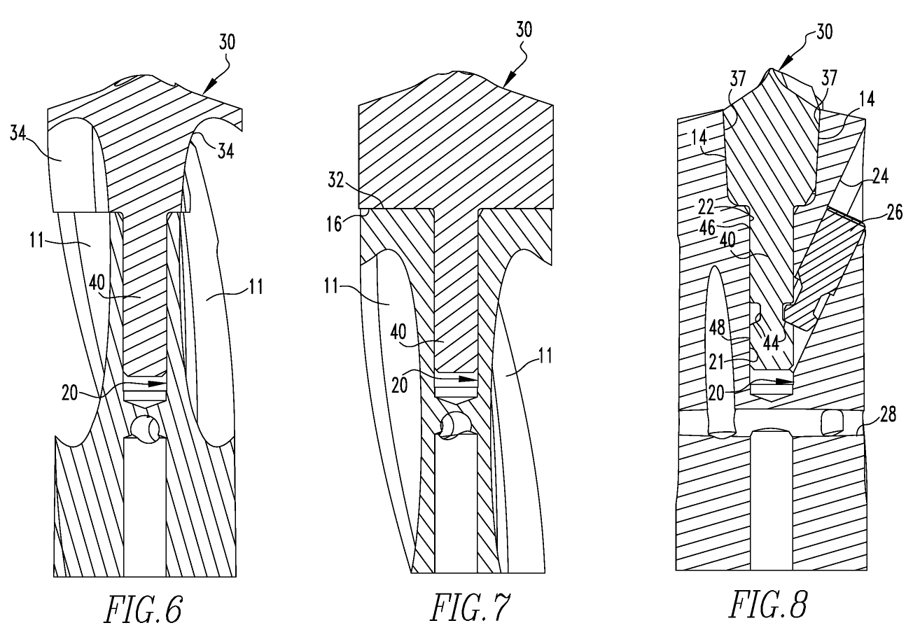

As shown in FIG. 9, coolant holes 18 and 19 may be provided in front surfaces of the shank 10 on opposite sides of the pocket 12. The coolant holes 18 and 19 shown in FIG. 9 are of different sizes. Alternatively, the coolant holes may be the same size. As shown in FIGS. 4 and 8, a coolant supply hole 28 may be provided through a sidewall of the shank 10.

As shown most clearly in FIGS. 6-13, a central pin-receiving hole 20 extends from the pocket floor 16 into the shank 10 along its central longitudinal axis. The pin-receiving hole 20 includes a rear tail contact region 21 structured and arranged to engage a rear end 42 of the cutting insert pin 40, as more fully described below. The pin-receiving hole 20 also includes a front contact region 22 that may engage a front end 41 of the pin 40, as more fully described below. A threaded set screw hole 24 extends at an angle through a side of the shank 10 and intersects the pin-receiving hole 20. A set screw 26 is threadingly receivable in the set screw hole 24.

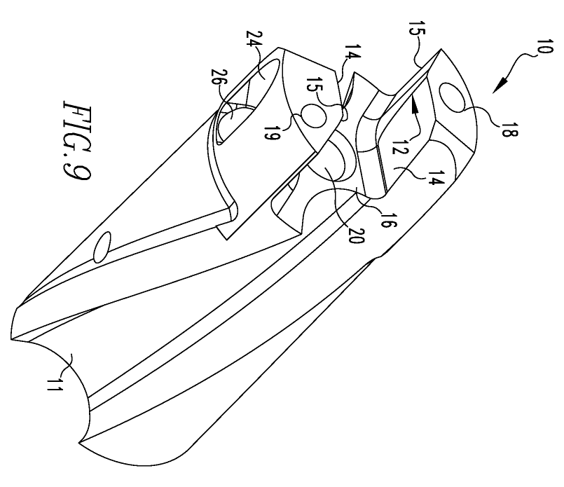

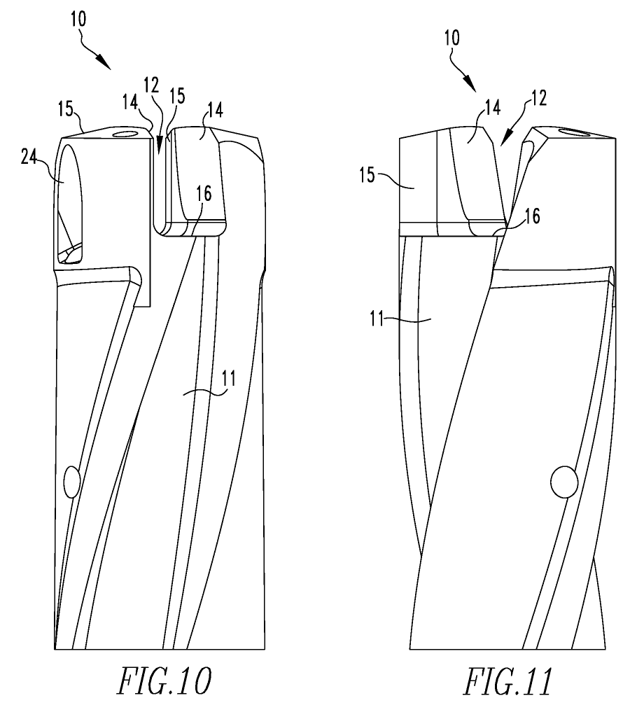

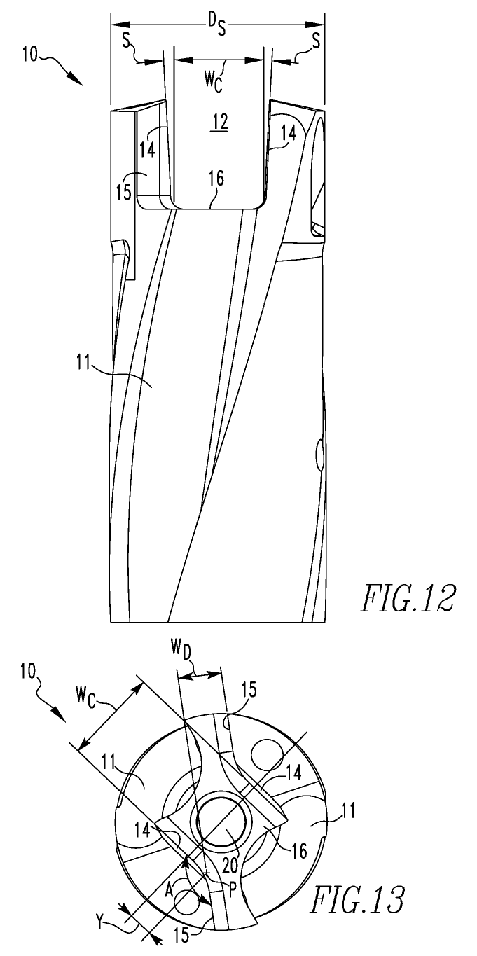

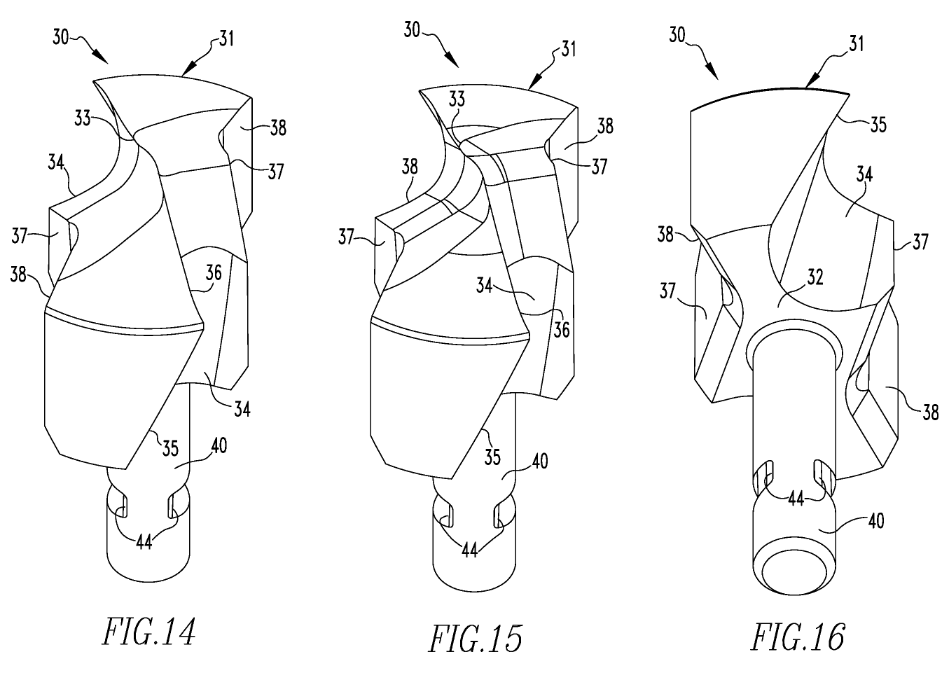

As shown most clearly in FIGS. 14-20, the cutting insert 30 has a central longitudinal axis and includes a head 31, rear face 32 and a front tip 33. Helical flutes 34 run along the sides of the head 31. Side edges 35 are provided adjacent to the flutes 34. In addition, front cutting edges 36 are provided at the front of the cutting insert head 31. The front cutting edges 36 may cut into a workpiece as the rotary cutting tool 5 is rotated. Once the cutting insert 30 is installed on the shank 10, the corresponding flutes 11 and 34 in the shank 10 and cutting insert 30, respectively, will align to form substantially continuous flutes 11, 34. Although two flutes are shown, any other number of flutes may be provided, e.g., one flute, three flutes, etc.

The cutting insert 30 includes centering surfaces 37 and torque transmission drive surfaces 38 that are structured and arranged for engagement with respective pocket centering walls 14 and pocket drive walls 15 of the front pocket 12 of the shank 10. The insert centering surfaces 37 may be slightly angled with respect to each other to match the seating angles S of the respective pocket centering walls 14. The insert drive surfaces 38 may be parallel with each other, and parallel with the central longitudinal axis of the insert 30, to match the parallel arrangement of the pocket drive walls 15.

The pin 40 extends rearwardly from the rear face 32 of the head 31 of the cutting insert 30. In the embodiment shown, the pin 40 and head 31 may be provided as a single or integral piece of material; however, they may alternatively be provided as separate components that are joined, threaded or otherwise mechanically fastened together. As shown in FIGS. 17 and 18, the pin 40 includes a front end 41 and rear end 42. Opposing notches 44 having set screw contact surfaces 45 extend radially inward on opposite sides of the pin 40. The pin 40 includes a front portion 46 and a tail 48, which are divided by the opposing notches 44. As more fully described below, the structure and size of the cutting insert head 31 and pin 40, including their relative dimensions, are controlled in accordance with the present invention.

As shown in FIG. 12, the shank 10 has a shank diameter D_{S}. As shown in FIG. 13, each pocket centering wall 14 and adjacent pocket drive wall 15 define planes that intersect each other in a plane of the pocket floor 16 at a pocket intersection point P. A pocket wall angle A is defined at the pocket intersection point P wherein the planes of the pocket centering wall 14 and pocket drive wall 15 meet. A pocket offset distance Y is defined as the distance measured on the pocket floor 16 in the plane of the pocket centering wall 14 extending perpendicularly from a plane in which the central longitudinal axis of the shank 10 is located to the pocket intersection point P, as shown in FIG. 13. As further shown in FIGS. 12 and 13, the pocket 12 has a centering wall width W_{C} measured at the pocket floor 16. As shown in FIG. 13 first and second drive walls 15 are spaced apart from each other. Each of the first and the second drive wall 15 being disposed in a plane parallel with the longitudinal axis such that a virtual extension of each of the first and second drive walls, across a diameter of the front pocket, projects unobstructed. As more fully described below, planar surface areas of each centering wall 14 and adjacent drive wall 15 may be selected in relation to each other. By controlling the structure, arrangement and dimensions of the features described above, the shanks of the present invention provide favorable properties such as improved torque transmission, rigidity and stability during operation of the rotary cutting tools.

As shown in FIGS. 17 and 20, each insert centering surface 37 and adjacent insert drive surface 38 define planes that intersect each other in a plane of the rear face 32 at an insert intersection point P′. An insert surface Angle A′ is defined at the insert intersection point P′. An insert offset distance Y′ is defined as the distance measured on the rear face 32 in the plane of the centering surface 37 extending perpendicularly from a plane in which the central longitudinal axis of the cutting insert 30 is located at the insert intersection point P′, as shown in FIG. 20. As further shown in FIG. 20, the insert has an insert centering surface width W′_{C} measured at the rear face 32, and a drive surface width W′_{D} measured at the rear face 32. As more fully described below, planar surface areas of each centering surface 37 and adjacent drive surface 38 may be selected in relation to each other. In accordance with the present invention, the insert surface angle A′, insert offset distance Y′ and other structural features described above are controlled to provide improved torque transmission, rigidity and stability during operation of the rotary cutting tools.

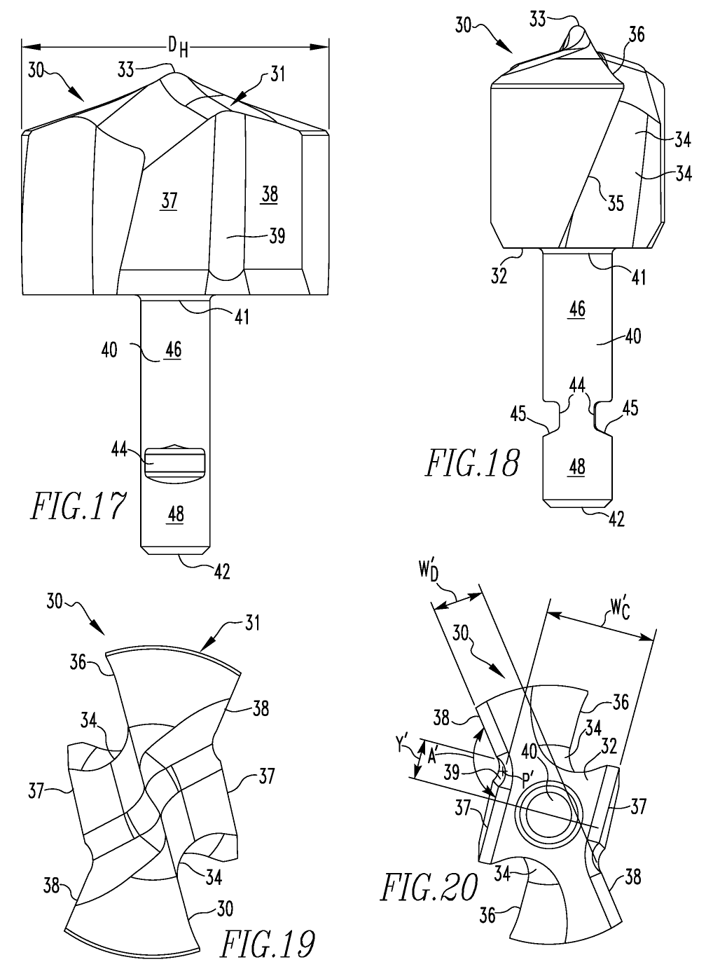

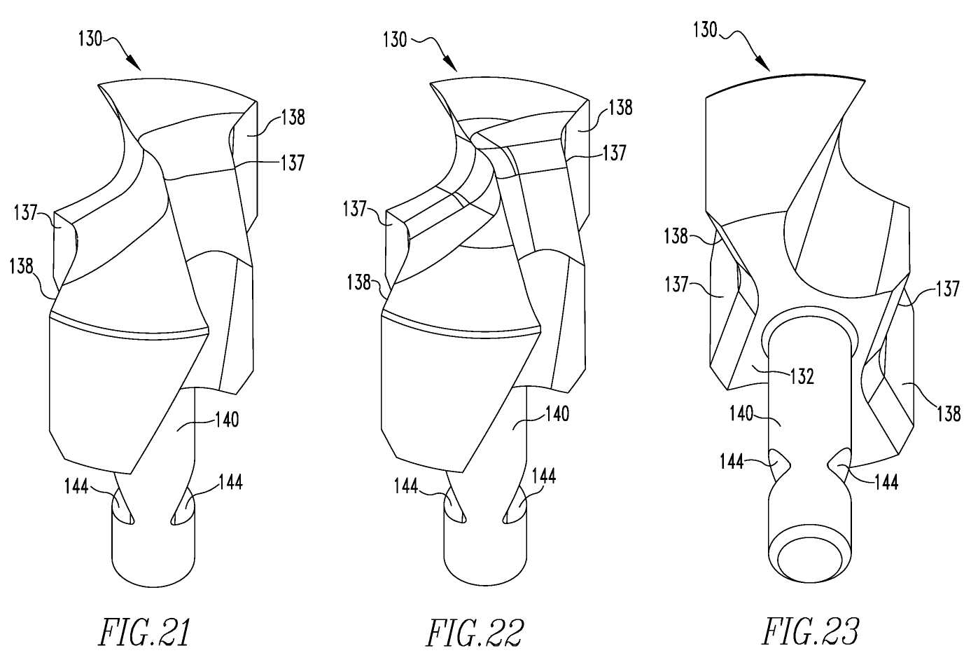

FIGS. 21-27 illustrate a cutting insert 130 in accordance with another embodiment of the present invention. The cutting insert 130 includes centering surfaces 137 and torque transmission drive surfaces 138. The cutting insert 130 includes a rearwardly extending pin 140 that extends rearwardly from a rear face 132 of the head of the cutting insert 130 having opposing notches 144. As shown in FIG. 27, the cutting insert 130 has an insert intersection point P′, insert surface angle A′, insert offset distance Y′, insert centering surface width W_{C}, and insert drive surface width W_{D}.

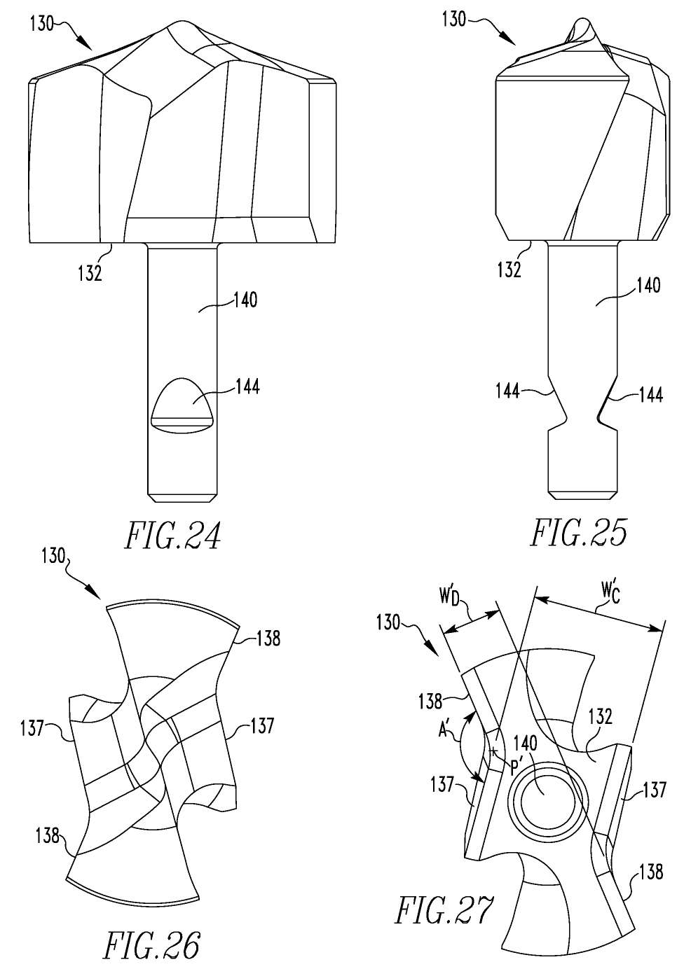

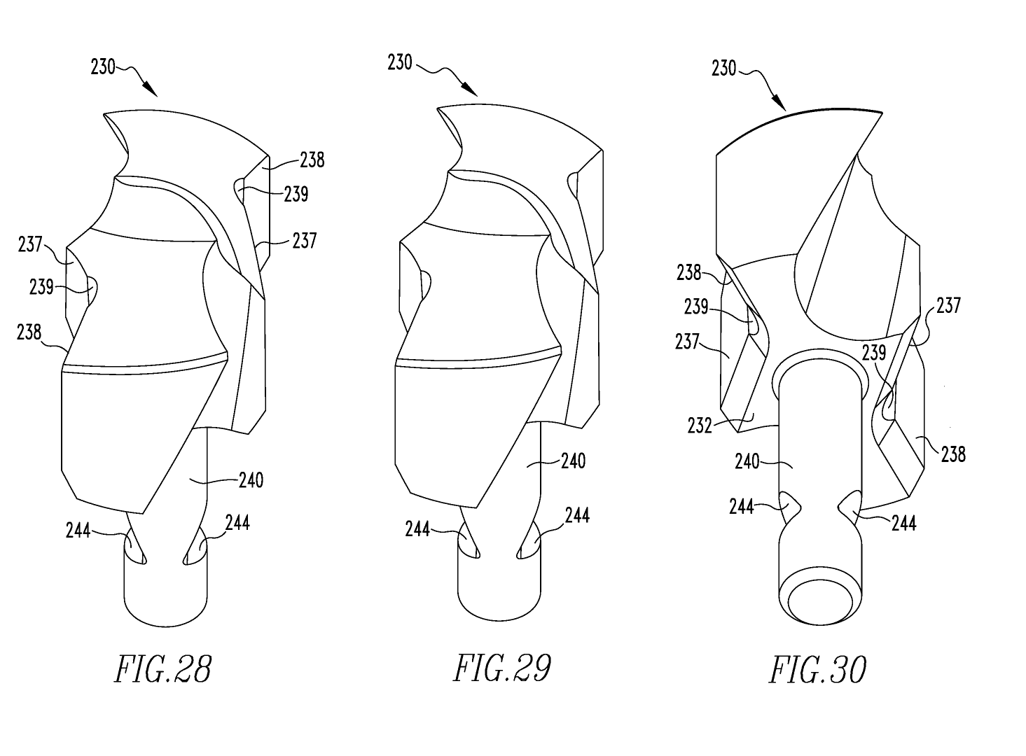

FIGS. 28-34 illustrate another cutting insert 230 in accordance with an embodiment of the present invention. The cutting insert 230 includes centering surfaces 237 and torque transmission drive surfaces 238. A relief channel 239 is provided between adjacent centering surfaces 237 and torque transmission drives surfaces 238. The cutting insert 230 includes a pin 240 that extends rearwardly from a rear face 232 of the head of the cutting insert 230 having opposing notches 244. As shown in FIG. 34, the cutting insert 230 has an insert intersection point P′, insert surface angle A′, insert offset distance Y′, insert centering surface width W_{C}, and insert drive surface width W_{D}.

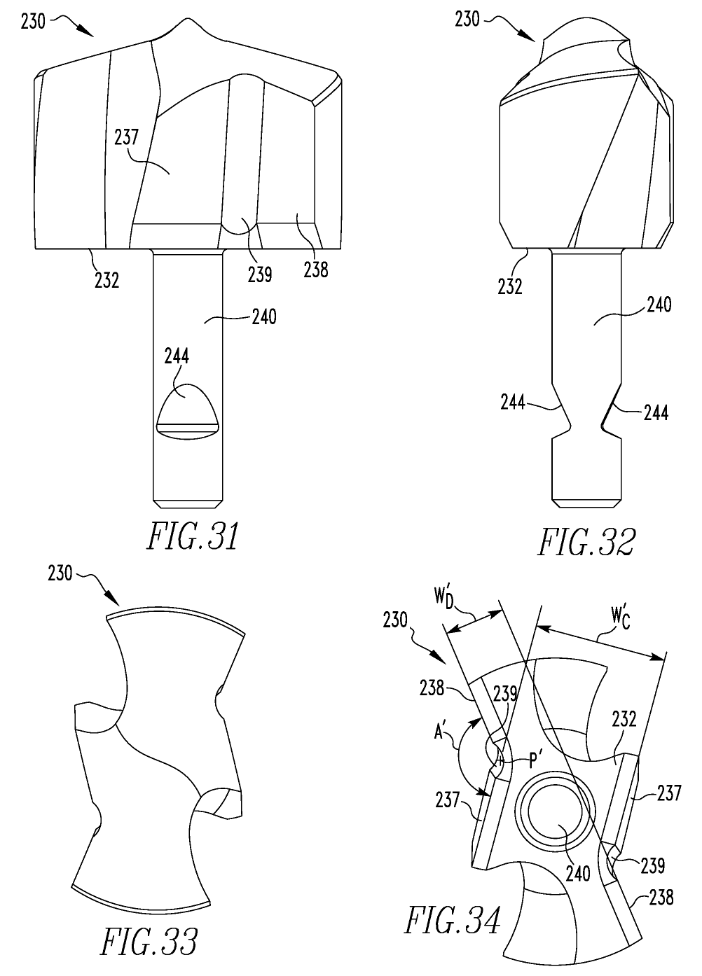

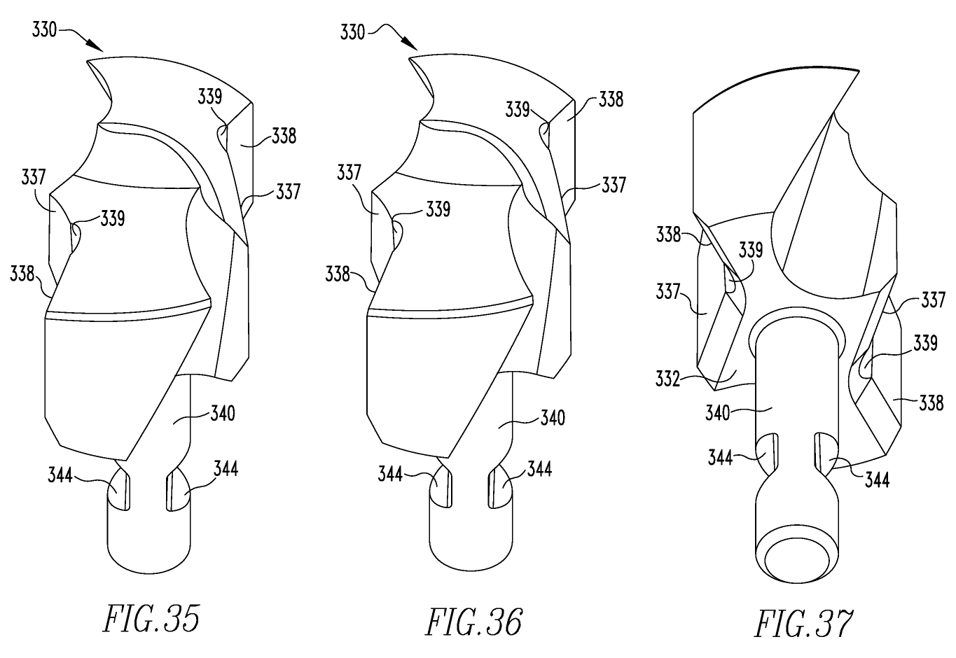

FIGS. 35-41 illustrate a cutting insert 330 in accordance with a further embodiment of the present invention. The cutting insert 330 includes centering surfaces 337 and torque transmission drive surfaces 338. A relief channel 339 is provided between adjacent centering surfaces 337 and torque transmission drives surfaces 338. The cutting insert 330 includes a pin 340 that extends rearwardly from a rear face 332 of the head of the cutting insert 330 having opposing notches 344. As shown in FIG. 41, the cutting insert 330 has an insert intersection point P′, insert surface angle A′, insert offset distance Y′, insert centering surface width W_{C}, and insert drive surface width W_{D}.

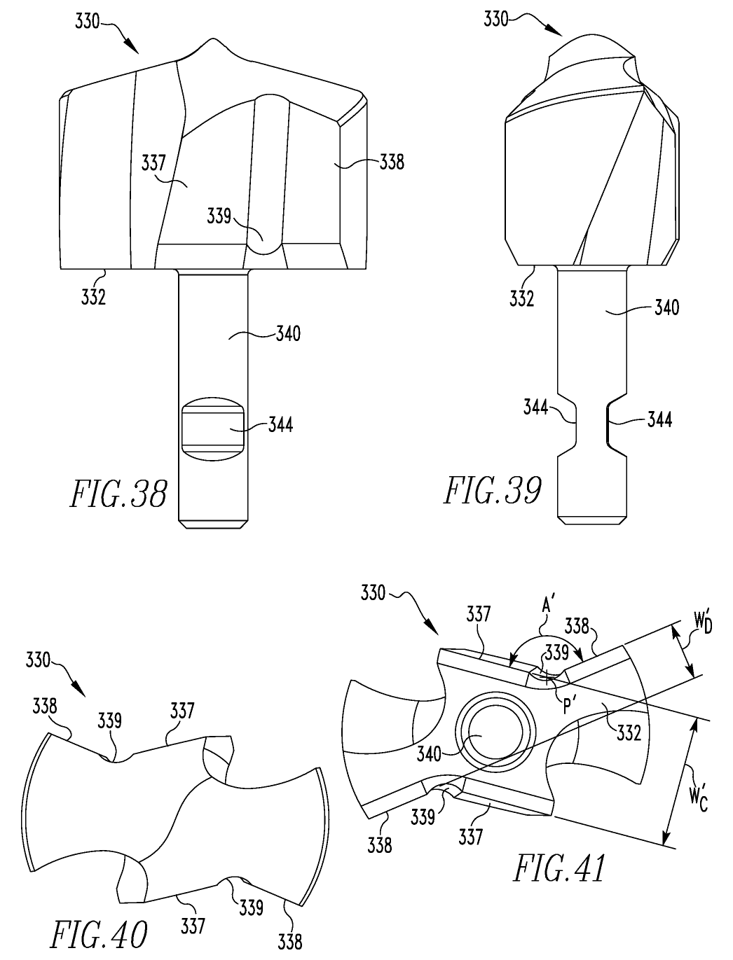

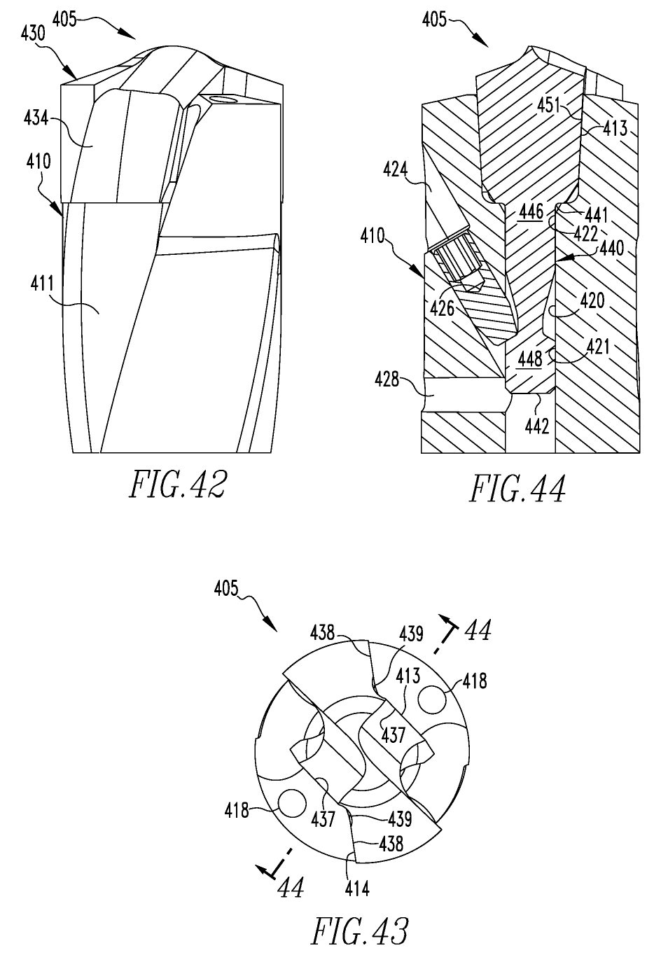

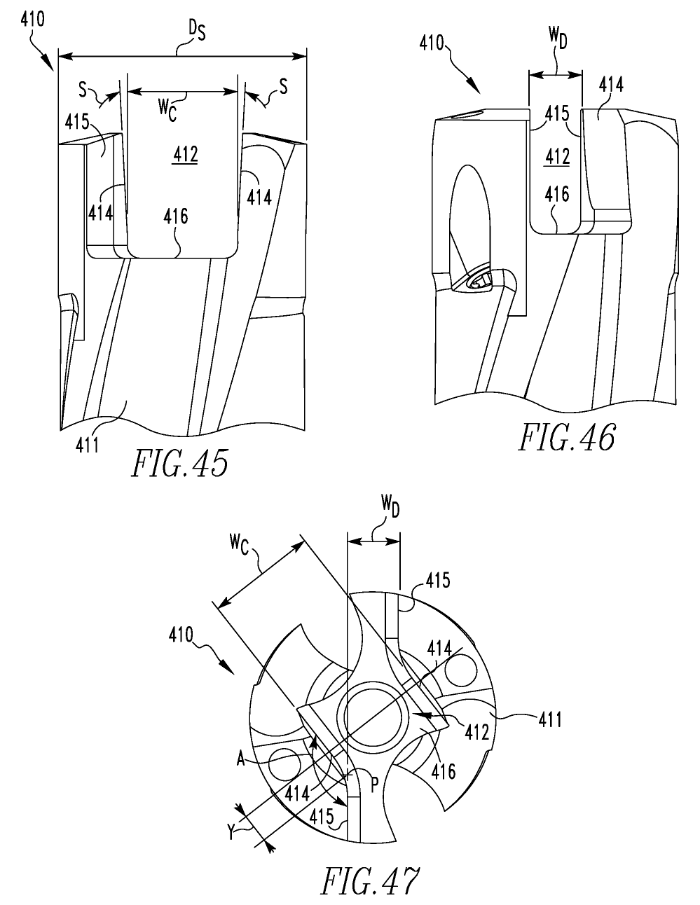

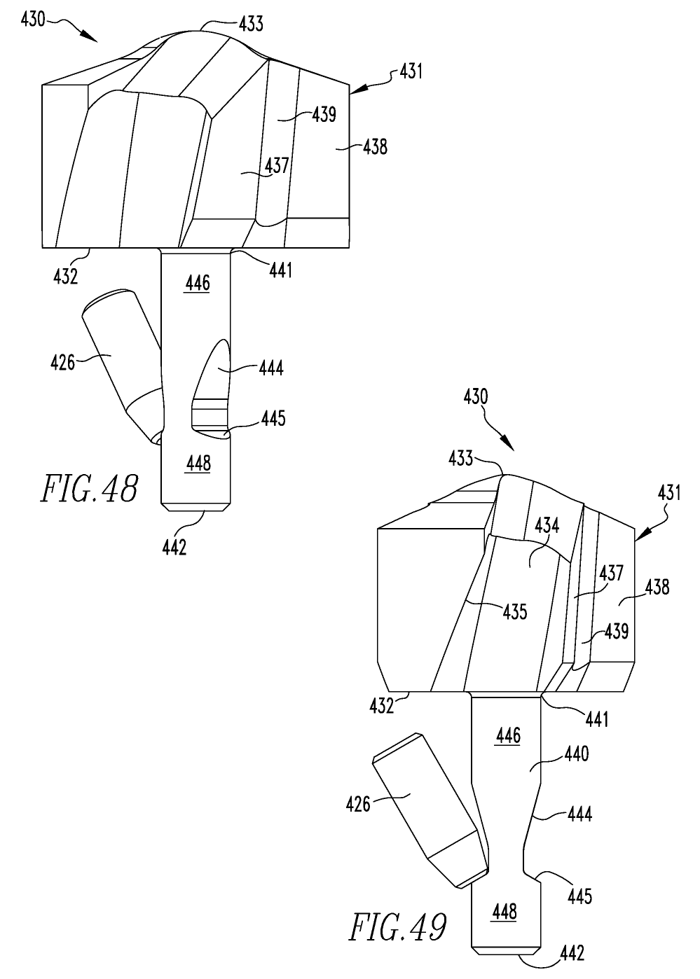

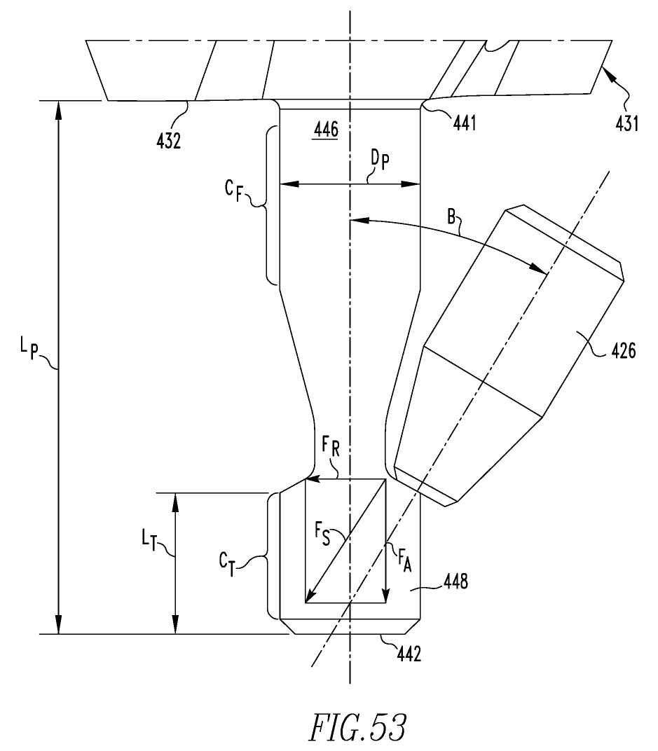

FIGS. 42-51 illustrate another modular rotary cutting tool 405 of the present invention including a shank 410 and cutting insert 430 having features in common with several of the features described in the embodiments above. The shank 410 includes helical flutes 411 and a front pocket 412. A floor 416 is provided at the bottom of the pocket 412. The pocket 412 includes opposing centering walls 414 and torque transmission drive walls 415. As shown in FIG. 45, the centering walls 415 of the pocket 416 may be oriented at a seating angle S, which may be selected as described above. Coolant holes 418 are provided in front surfaces of the shank 410 on opposite sides of the pocket 412, and may be the same size or different sizes. The shank 410 includes a central pin-receiving hole 420 having a tail contact region 421 and front contact region 422, as more fully described below. As shown most clearly in FIGS. 44 and 53, a threaded set screw hole 424 receives a threaded set screw 426 and extends at an angle B with respect to the longitudinal axis of the shank 410 from a side of the shank to the pin-receiving hole 420. A bump-off hole 428 extends radially through the side of the shank 410 and intersects the pin-receiving hole 420.

The cutting insert 430 includes a head 431, rear face 432 and front tip 433. Helical flutes 434 are provided along the side of the cutting insert 430. Side edges 435 are provided adjacent the flutes 434, and front cutting edges 436 are provided at the front of the head 431.

The cutting insert 430 includes centering surfaces 437 and torque transmission drive surfaces 438. As described in the embodiments above, the insert centering surfaces 437 may be slightly angled with respect to each other to match seating the angles S of the respective pocket centering walls 414 of the pocket 412 of the shank 410. The insert drive surfaces 438 may be parallel with each other in planes that are parallel with the central longitudinal axis of the cutting insert 430. A relief channel 439 is provided between adjacent centering surfaces 437 and torque transmission drives surfaces 438.

The cutting insert 430 includes a pin 440 having a front end 441 and rear end 442. As described above, the pin 440 may be integrally formed with the head 431, or may be provided as a separate component that is joined or mechanically fastened to the head 431, e.g., the head 431 may comprise a carbide material and the pin 440 may comprise a steel material fastened to the head. Opposing notches 444 including set screw contact surfaces 445 are provided on the side of the pin 440. The pin 440 includes a front portion 446 and a tail 448 divided by the opposing notches 444. In the embodiment shown, the notches 444 are located on opposite sides of the pin 440 circumferentially spaced 180° from each other. Alternatively, a single groove may extend 360° circumferentially around the pin 440.

The shank 410 has a diameter D_{S} and the pocket 412 has a centering wall width W_{C} measured at the pocket floor 416, as shown in FIG. 45. The pocket 412 also has a drive wall width W_{D}, as shown in FIG. 46. As shown in FIG. 47, each pocket centering wall 414 and adjacent pocket drive wall 415 define planes that intersect each other in a plane of the pocket floor 416 at a pocket intersection point P. A pocket wall angle A is defined at the pocket intersection point P where the planes of the pocket centering wall 414 and pocket drive wall 415 meet. A pocket offset distance Y is defined as the distance measured on the pocket floor 416 in the plane of the pocket centering wall 414 extending perpendicularly from a plane in which the central longitudinal axis of the shank 10 is located to the pocket intersection point P, as shown in FIG. 47. As further shown in FIGS. 45-47, the pocket 412 has a centering wall width W_{C} measured at the pocket floor 416, and a drive wall width W_{D}, measured at the pocket floor 416. Planar surface areas of each centering wall 414 and adjacent drive wall 415 may be selected in relation to each other. The planar surface area of each pocket centering wall 414 may be designated as SA_{C}, while the planar surface area of each pocket drive wall 415 may be designated as SA_{D}. The pocket drive wall surface area SA_{D} may be controlled as a percentage of the pocket centering wall surface area SA_{C}, i.e., the SA_{D}/SA_{C} percentage. By controlling the structure, arrangement and dimensions of the features described above, the shanks of the present invention provide favorable properties such as improved torque transmission, rigidity and stability during operation of the rotary cutting tools.

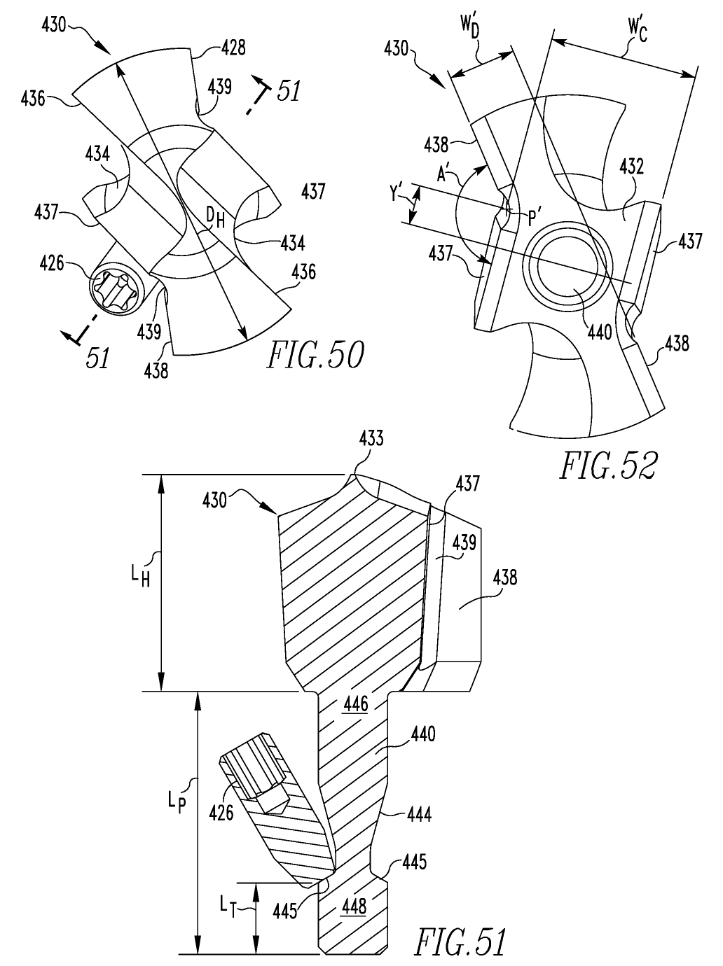

As shown in FIGS. 50 and 52, the head of the insert 430 has an insert head diameter D_{H}, an insert centering surface width W′_{C}, and insert drive surface width W′_{D}. As shown in FIG. 52, each insert centering surface 437 and adjacent insert drive surface 438 define planes that intersect each other in a plane of the rear face 432 at an insert intersection point P′. An insert surface Angle A′ is defined at the insert intersection point P′. An insert offset distance Y′ is defined as the distance measured on the rear face 432 in the plane of the centering surface 437 extending perpendicularly from a plane in which the central longitudinal axis of the cutting insert 430 is located at the insert intersection point P′, as shown in FIG. 52. As further shown in FIG. 52, the insert has an insert centering surface width W′_{C} measured at the rear face 432, and a drive surface width W′_{D} measured at the rear face 432. The planar surface areas of each centering surface 437 and adjacent drive surface 438 may be selected in relation to each other. The planar surface area of each insert centering surface 414 may be designated as SA′_{C}, while the planar surface area of each insert drive surface 415 may be designated as SA′_{D}. The insert drive surface area SA′_{D} may be controlled as a percentage of the insert centering surface SA′_{C}, i.e., the SA′_{D}/SA′_{C} percentage. In accordance with the present invention, the insert surface angle A′, insert offset distance Y′ and other structural features described above are controlled to provide improved torque transmission, rigidity and stability during operation of the rotary cutting tools.

As most clearly shown in FIGS. 51 and 53, the pin 440 has an overall length L_{P}, and a tail length L_{T} measured from the rear of the notch 444 to the rear end 442 of the pin. The pin 440 has a diameter D_{P}. As further shown in FIG. 53, the set screw 426 is provided at a set screw angle B measured between a central longitudinal axis of the set screw 426 and the central longitudinal axis of the pin 440. The set screw angle B corresponds to a similar angle of the set screw hole 424 in the shank 410 as shown in FIG. 44, as measured between a central longitudinal axis of the set screw hole 424 and the central longitudinal axis of the shank 410. The set screw angle B, and corresponding set screw hole angle, may typically be from 20 to 40°, for example, from 25 to 35°, or from 28 to 32°. As schematically shown in FIG. 53, during installation and retention of the cutting insert 430 in the shank 410, the set screw 426 generates a set screw force F_{S} along the longitudinal axis of the set screw 426 at the set screw angle B. The set screw force F_{S} has an axial component F_{A} that acts to force the pin 440 axially into the pin-receiving hole 420, and a radial component F_{R} that acts to radially force portions of the pin 440 against opposing surfaces of the pin-receiving hole 420 to thereby bend or deform the pin 440 a controlled amount, as more fully described above.

A clearance gap G is provided between the pin 440 and pin-receiving hole 420 of the shank 410. The provision of such a clearance gap G allows the tail 448 of the pin 440 to deform a controlled amount in a radial direction along the radial component F_{R} of the set screw force F_{S}. This creates a tail contact region C_{T} at the tail 448 that engages with an opposing rear inner surface 421 of the pin-receiving hole 420. A forward contact region C_{F} at the front portion 446 of the pin 440 may also contact an opposing front inner surface 442 of the pin-receiving hole 420.

The pocket wall angle A described above may be greater than 90°, or greater than 125°, or greater than 135°, or greater than 140°. The pocket wall angle A may be less than 155°, or less than 150°, or less than 148°, or less than 145°. The pocket wall angle A may range from 90 to 150°, for example, from 125 to 150°, or from 135 to 148°, or from 140 to 145°.

The insert surface angle A′ described above may be greater than 90°, or greater than 125°, or greater than 135°, or greater than 140°. The insert surface angle A′ may be less than 155°, or less than 150°, or less than 148°, or less than 145°. The insert surface angle A′ may range from 90 to 150°, for example, from 125 to 150°, or from 135 to 148°, or from 140 to 145°.

The pocket offset distance Y described may be selected as a percentage of the shank diameter D_{S}. The Y/D_{S} percentage may be greater than 0.5%, or greater than 1%, or greater than 2%, or greater than 2.5%, or greater than 3%, or greater than 5%. The Y/D_{S} percentage may be less than 20%, or less than 17%, or less than 15%. The Y/D_{S} percentage may range from 1 to 20%, for example, from 2.5 to 17%, or from 3 to 15%, or from 5 to 14%.

The insert offset distance Y′ described above may be selected as a percentage of the insert head diameter D_{H}. The Y′/D_{H} percentage may be greater than 0.5%, or greater than 1%, or greater than 2%, or greater than 2.5%, or greater than 3%, or greater than 5%. The Y′/D_{H} percentage may be less than 20%, or less than 17%, or less than 15%. The Y′/D_{H} percentage may range from 1 to 20%, for example, from 2.5 to 17%, or from 3 to 15%, or from 5 to 14%.

The pocket centering wall width W_{C} described above may be selected as a percentage of the shank diameter D_{S}. The W_{C}/D_{S} percentage may be greater than 15%, or greater than 16%, or greater than 18%. The W_{C}/D_{S} percentage may be less than 30%, or less than 28%, or less than 25%, or less than 23%. The W_{C}/D_{S} percentage may range from 15 to 30%, for example, from 16 to 28%, or from 18 to 25%, or from 18 to 23%.

The insert centering surface width W′_{C} described above may be selected as a percentage of the insert head diameter D_{H}. The W′_{C}/D_{H} percentage may be greater than 15%, or greater than 16%, or greater than 18%. The W′_{C}/D_{H} percentage may be less than 30%, or less than 28%, or less than 25%, or less than 23%. The W′_{C}/D_{H} percentage may range from 15 to 30%, for example, from 16 to 28%, or from 18 to 25%, or from 18 to 23%.

The pocket drive wall width W_{D} described above may be selected as a percentage of the pocket centering wall width W_{C}. The W_{D}/W_{C} percentage may be greater than 1%, or greater than 10%, or greater than 15%, or greater than 25%, or greater than 28%. The W_{D}/W_{C} percentage may be less than 100%, or less than 90%, or less than 85%, or less than 75%, or less than 60%. The W_{D}/W_{C} percentage may range from 1 to 100%, for example, from 10 to 90%, or from 15 to 85%, or from 25 to 75%, or from 28 to 60%.

The insert drive surface width W′_{D} described above may be selected as a percentage of the insert centering surface width W′_{C}. The W′_{D}/W′_{C} percentage may be greater than 1%, or greater than 10%, or greater than 15%, or greater than 25%, or greater than 28%. The W′_{D}/W′_{C} percentage may be less than 100%, or less than 90%, or less than 85%, or less than 75%, or less than 60%. The W′_{D}/W′_{C} percentage may range from 1 to 100%, for example, from 10 to 90%, or from 15 to 85%, or from 25 to 75%, or from 28 to 60%.

The pocket drive wall surface area SA_{D} may be selected as a percentage of the pocket centering wall surface area SA_{C}. The SA_{D}/SA_{C} percentage may be greater than 30%, or greater than 34%, or greater than 50%, or greater than 70%, or greater than 75%. The SA_{D}/SA_{C} percentage may be less than 200%, or less than 190%, or less than 145%, or less than 130%, or less than 120%. The SA_{D}/SA_{C} percentage may range from 40 to 170%, for example, from 45 to 165%, or from 50 to 135%, or from 65 to 125%.

The insert drive surface area SA′_{D} may be selected as a percentage of the insert centering surface area SA′_{C}. The SA′_{D}/SA′_{C} percentage may be greater than 30%, or greater than 34%, or greater than 50%, or greater than 70%, or greater than 75%. The SA′_{D}/SA′_{C} percentage may be less than 200%, or less than 190%, or less than 145%, or less than 130%, or less than 120%. The SA′_{D}/SA′_{C} percentage may range from 40 to 170%, for example, from 45 to 165%, or from 50 to 135%, or from 65 to 125%.

The total insert pin length L_{P} and the insert head length L_{H} may be selected as a ratio. The L_{P}:L_{H} ratio may be greater than 1:1, or greater than 1.05:1, or greater than 1.1:1. The L_{P}:L_{H} ratio may be less than 2:1, or less than 1.9:1, or less than 1.8:1, or less than 1.5:1. The L_{P}:L_{H} ratio may range from 1:1 to 2:1, for example, from 1.1:1 to 1.8:1, or from 1.1:1 to 1.6:1, or from 1.1:1 to 1.5:1.

The pin tail length L_{T} may be selected as a percentage of the total pin length L_{P}. The L_{T}/L_{P} percentage may be greater than 20%, or greater than 22%, or greater than 24%, or greater than 25%. The L_{T}/L_{P} percentage may be less than 40%, or less than 35%, or less than 33%, or less than 32%. The L_{T}/L_{P} percentage may range from 20 to 40%, for example, from 22 to 35%, or from 24 to 33%, or from 25 to 32%.

The total pin length L_{P} and the pin diameter D_{P} may be selected as a ratio. The L_{P}:D_{P} ratio may be greater than 3:1, or greater than 3.2:1, or greater than 3.4:1, or greater than 3.5:1. The L_{P}:D_{P} ratio may be less than 6:1, or less than 5:1, or less than 4:5.1, or less than 4.0:1. The L_{P}:D_{P} ratio may range from 3.0:1 to 6.0:1, for example, from 3.2:1 to 5:1, or from 3.4:1 to 4.5:1, or from 3.5:1 to 4.0:1.

The pin tail length L_{T} and the pin diameter D_{P} may be selected as a ratio. The L_{T}:D_{P} ratio may be greater than 0.95:1, or greater than 1.0:1, or greater than 1.05:1. The L_{T}:D_{P} ratio may be less than 2.0:1, or less than 1.8:1, or less than 1.6:1, or less than 1.5:1. The L_{T}:D_{P} ratio may range from 0.95:1 to 2.0:1, for example, from 1.0:1 to 1.8:1, or from 1.0:1 to 1.6:1, or from 1.05:1 to 1.5:1.

The pin diameter D_{P} may be selected as a percentage of the insert head diameter D_{H}. The D_{P}/D_{H} percentage may be greater than 15%, or greater than 17%, or greater than 19%, or greater than 20%. The D_{P}/D_{H} percentage may be less than 30%, or less than 27%, or less than 25%, or less than 24%. The D_{P}/D_{H} percentage may range from 15 to 30%, for example, from 17 to 27%, or from 19 to 25%, or from 20 to 24%.

The clearance gap G, e.g., between the hole 420 and pin 440, may be greater than 0 mm, or greater than 0.002 mm, or greater than 0.003 mm, or greater than 0.004 mm, or greater than 0.005 mm. The clearance gap G may be less than 0.1 mm, or less than 0.08 mm, or less than 0.05 mm. The clearance gap G may range from 0.002 to 0.1 mm, or from 0.003 to 0.08 mm, or from 0.004 to 0.06 mm, or from 0.005 to 0.05 mm.

The present pocket and insert designs provide superior torque transmission capability, rigidity and stability under side loads. Good correlation has been found between the offset distance and performance. When the offset distance falls within the values listed above, the pocket stresses are under controlled limits providing a robust design. It has been found that the resultant contact area between the pocket centering walls and insert centering surfaces is sufficiently large to avoid premature wear under cyclic loads. By providing the offset distances described herein, small contact areas may be provided between the pocket centering walls and the insert centering surfaces that help transmit the torque, along with torque transmittal from the pocket drive walls to the insert drive surfaces. The stresses caused by the additional contact in the centering portions act in different regions than stresses created by the torque being transmitted in the drive regions. However, values for the offset distances that are too large will cause the cross section of the insert to be too small, and may become the weakest point in the system.

Because of the gap G between the pin 440 and the pin-receiving hole 420 and the angle B from the longitudinal axis of the set screw to the longitudinal axis of the pin, a force applied by the setscrew 426 will create a vertical component necessary for clamping, and a lateral component which will try to bend the pin and can cause the insert to be clamped slightly tilted or off-center. Deformation of the pin 440 and contact between its tail 448 and the opposing inner wall of the pin-receiving hole 420 adds stability and reduces the relative motion between the cutting insert 430 and pocket 412, especially when oscillating side loads are generated in a drilling operation, e.g., when drilling in angled surfaces, or cross-holes.

By utilizing a pin with a high L_{P}/D_{P} ratio, contact is achieved between the pin and the hole and additional clamping force can be applied without generating extra stresses on the pin close to the seating surface. A long pin can also store more elastic deformation than a short pin, which maintains the system preloaded and prevents setscrew from coming loose due to vibration, wear or thermal expansion components. The combination of a long pin with a small angle B, which allows for a longer setscrew, leads to higher summation of elastic deformation, e.g., stored energy. By making the pin longer, there is sufficient contact between the pin and the hole and, due to the relatively large diameter of the pin, there may be an increase in stiffness of the system. High pressure caused by the contact may be reduced by providing a relatively high L_{T}:D_{P} ratio, and the combination of a high L_{P}:D_{P} ratio with a high L_{T}:D_{P} ratio leads to an improved design.

Additionally, the selected L_{T}:D_{P} ratio creates enough support area to keep the contact pressure with the hole to a minimum. Higher contact pressure is found on the tail portion and depends on how stiff the pin is (directly affected by L_{P}/D_{P}), the gap G, and the force applied by the setscrew. Reducing the contact pressure allows for a higher force to be applied by the setscrew which in turn creates a more stable connection between the insert and the pocket. The relatively high ratio also allows a reduction in stress at the notch 444 region of the pin 440.

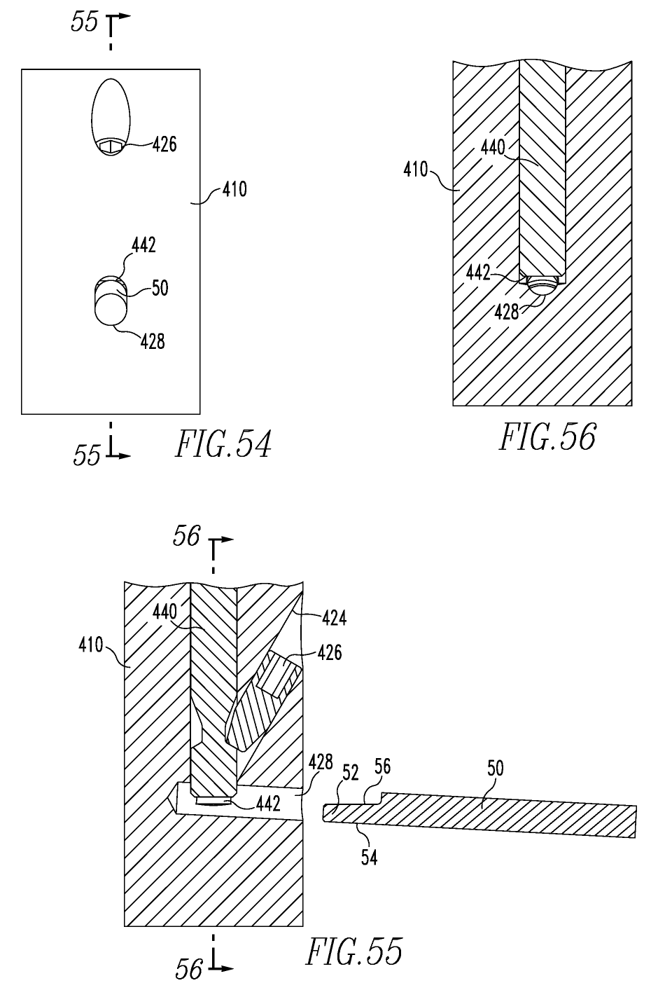

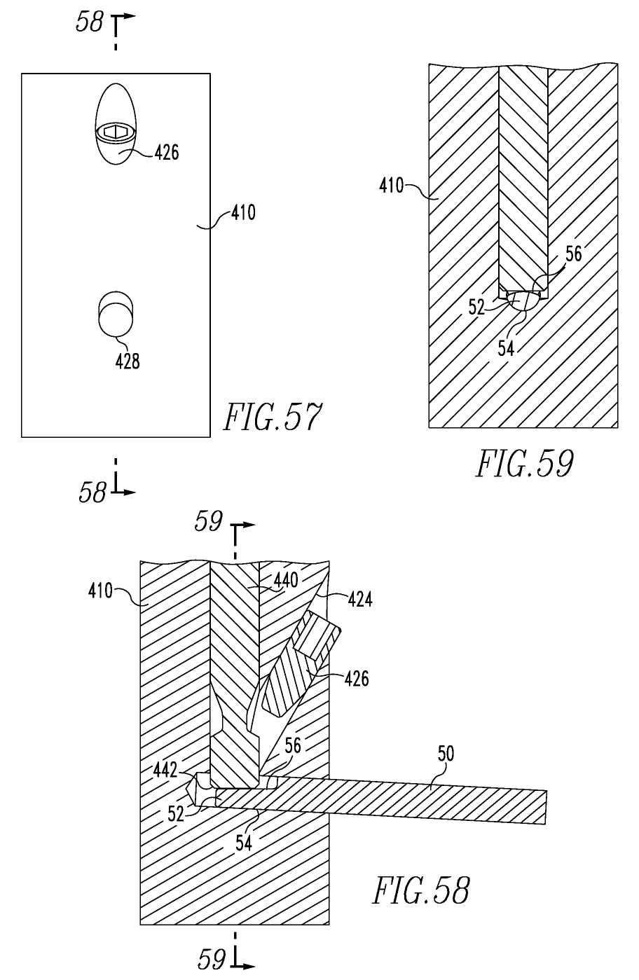

FIGS. 54-59 illustrate a bump-off tool 50 that may be used to remove the cutting inserts of the present invention from the cutting tool shanks, e.g., for purposes of replacement, inspection, sharpening or repair. The bump-off tool 50 includes a cam tip 52 at an end thereof. The body of the bump-off tool 50 may include a generally circular cross section, while the cam tip comprises a portion having a generally cylindrical outer surface 54 and a cam surface 56. Although not shown in the figures, an opposite end of the bump-off tool 50 may include a keyed end receivable in a corresponding recess in the set screw for tightening and loosening the set screw, and the bump-off tool may be generally L-shaped to facilitate bump-off operation as well as set screw tightening.

As further shown in FIGS. 54-59, a bump-off hole 428 extends radially through a sidewall of the shank 410 and intersects the pin-receiving hole 420 in a region of the rear end 442 of the pin 440. For example, the rear end 442 may extend at least 10%, or at least 20%, or at least 30%, or at least 40% into the diameter of the bump-off hole 428, as shown in FIGS. 44, 55 and 58. Although the radially-extending bump-off hole is at a slight angle, e.g., from 5° to 30°, or from 15° to 25°, from perpendicular to the central longitudinal axis of the shank 410 in the embodiment shown, it may alternatively be provided perpendicularly. In FIGS. 55 and 56, the cam tip 52 is aligned externally of the bump-off hole 428. In FIGS. 58 and 59, the cam tip 52 has been inserted in the bump-off hole 428 to a position in which the cam surface 56 contacts the rear end 442 of the pin 440. Upon rotation around the central longitudinal axis of the bump-off tool 50 from the position shown, the cam surface 56 is forced against the rear end 442, thereby forcing the pin 440 axially in an extraction direction through the pin-receiving hole 420. The cam tip 52 thereby exerts sufficient force to remove the cutting insert 430 from the shank 410.

For purposes of this detailed description, it is to be understood that the invention may assume various alternatives and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “from 1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses singular, unless specifically stated otherwise. For example, although reference is made herein to “a” powder composition, “a” cemented carbide body, and “an” apparent density, a combination (i.e., a plurality) of these components may be used.

In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A modular rotary cutting tool comprising:
a shank having a central longitudinal axis and comprising a central pin-receiving hole and a front pocket, the front pocket comprising:
first and second opposing pocket centering walls wherein each of the first and second opposing pocket centering walls are disposed at a seating angle S of great than 0.5° measured from the longitudinal axis of the shank;
first and second torque transmission pocket drive walls; and
a pocket floor; and
a cutting insert removably installable in the front pocket of the shank comprising a pin receivable in the pin-receiving hole of the shank,
wherein the first pocket centering wall defines a plane, the first pocket drive wall defines another plane, the first pocket centering wall plane and the first pocket drive wall plane intersect at a pocket intersection point P located at the pocket floor at a pocket wall angle A measured at the intersection point P, and the pocket wall angle A is from greater than 90° to less than 155°, wherein each of the first and second pocket drive walls are spaced apart from each other in planes parallel with the longitudinal axis of the shank such that a virtual extension of each of the first and second drive walls project unobstructed across a diameter of the front pocket,
wherein the first pocket centering wall has a planar area Sac, the first pocket drive wall has a planar surface area Sao, and the planar surface area of the first pocket drive Sao wall is from 50 to 135% of the planar surface area Sac of the first pocket centering wall.

2. The modular rotary cutting tool of claim 1, wherein each of the first and second opposing pocket centering walls are disposed at a seating angle S of greater than 0.5° measured from the longitudinal axis of the shank.

3. The modular rotary cutting tool of claim 1, wherein the cutting insert comprises a head having a length L_{H} measured in an axial direction of the cutting insert, a pin extending rearwardly from the head in the axial direction having a length L_{P} and a pin to head length ratio L_{P}:L_{H} is greater than 1:1.

4. The modular rotary cutting tool of claim 3, wherein the pin to head ratio L_{P}:L_{H} is from 1.1:1 to 1.6:1.

5. The modular rotary cutting tool of claim 3, wherein the pin comprises at least one side notch located between a front end of the pin and a rear end of the pin and defining a tail of the pin having a length L_{T} and the pin tail length L_{T} is greater than 20% of a pin total length L_{P}.

6. The modular rotary cutting tool of claim 5, wherein the pin tail length L_{T} is from 24 to 33% of the pin total length L_{P}.

7. The modular rotary cutting tool of claim 5, wherein the pin tail length L_{T} is greater than a diameter of the pin D_{P}.

8. The modular rotary cutting tool of claim 7, wherein a pin tail length to pin diameter ratio L_{T}:D_{P} is from 1.0:1 to 1.6:1.

9. The modular rotary cutting tool of claim 5, comprising two of the side notches on opposite sides of the pin circumferentially spaced 180° from each other.

10. The modular rotary cutting tool of claim 1, wherein the pin has a diameter D_{P} the pin-receiving hole has a diameter D_{H} greater than the pin diameter D_{P} and a clearance gap G is provided between the pin and the pin-receiving hole.

11. The modular rotary cutting tool of claim 10, wherein the clearance gap G is at least 0.002 mm.

12. The modular rotary cutting tool of claim 11, wherein the clearance gap G is from 0.005 to 0.05 mm.

13. A cutting insert for a modular rotary cutting tool having a central longitudinal axis and comprising a head and a pin extending rearwardly from the head, the head comprising:
first and second insert centering surfaces;
first and second torque transmission insert drive surfaces; and
a rear face,
wherein the first insert centering surface defines a plane, the first insert drive surface defines another plane, the first insert centering surface plane and the first insert drive surface plane intersect at an insert intersection point P′ located in a plane of the rear surface at an insert surface angle A′ measured at the intersection point P′, and the insert surface angle A′ is from greater than 90° to less than 155°, and wherein each of the first and second insert drive surfaces are disposed in planes parallel with the longitudinal axis of the shank.

14. The cutting insert for a modular rotary cutting tool of claim 13, wherein the insert surface angle A′ is from 130 to 150°.

15. The cutting insert for a modular rotary cutting tool of claim 13, wherein the insert intersection point P′ is located at an insert offset distance Y′ measured in the plane of the rear surface in a direction in the first insert centering surface plane from a plane in which the central longitudinal axis of the insert is located, and the insert offset distance Y′ is from 1 to 20% of a diameter of the head D_{H}.

16. The cutting insert for a modular rotary cutting tool of claim 15, wherein the insert offset distance Y′ is from 3 to 15% of the head diameter D_{H}.

17. The cutting insert for a modular rotary cutting tool of claim 13, wherein the first and second insert centering surfaces define an insert centering surface width W′_{C} measured in a plane of the rear surface, the first and second insert drive surfaces define an insert drive surface width W′_{D} measured in the plane of the rear surface, and the insert drive surface with W′_{D} is at least 10% of the insert centering surface width W′_{C}.

18. The cutting insert for a modular rotary cutting tool of claim 17, wherein the insert drive surface width W′_{D} is from 25 to 75% of the insert centering surface width W′_{C}.

19. The cutting insert for a modular rotary cutting tool of claim 13, wherein each of the first and second insert centering surfaces are disposed at a seating angle S of at least 0.5° measured from the longitudinal axis of the insert.

20. The cutting insert for a modular rotary cutting tool of claim 19, wherein the seating angle S is from 1 to 4°.

21. The cutting insert for a modular rotary cutting tool of claim 13, wherein the pin has a substantially constant outer diameter along an axial length of the pin.

22. The cutting insert for a modular rotary cutting tool of claim 13, wherein the first insert centering surface has a planar surface area SA′_{C} the first insert drive surface has a planar surface area SA′_{D} and the planar surface area SA′_{D} of the insert drive surface is from 50 to 135% of the planar surface area SA′_{C} of the first centering surface.

23. A cutting insert for a modular rotary cutting tool comprising:
a head having a length L_{H} measured in an axial direction of the cutting insert; and
a pin extending rearwardly from the head in the axial direction having a length L_{P}
wherein a pin to head length ratio L_{P}:L_{H} is greater than 1:1.

24. The cutting insert for a modular rotary cutting tool of claim 23, wherein the pin to head ratio L_{P}:L_{H} is from 1.1:1 to 1.6:1.

25. The cutting insert for a modular rotary cutting tool of claim 23, wherein the pin comprises at least one side notch located between a front end of the pin and a rear end of the pin and defining a tail of the pin having a length L_{T} wherein the tail length L_{T} is greater than 20% of the pin length L_{P}.

26. The cutting insert for a modular rotary cutting tool of claim 25, wherein the tail length L_{T} is from 24 to 33% of the pin length L_{P}.

27. The cutting insert for a modular rotary cutting tool of claim 25, wherein the tail length L_{T} is greater than a diameter of the pin D_{P}.

28. The cutting insert for a modular rotary cutting tool of claim 27, wherein a pin tail length to pin diameter ratio L_{T}:D_{P} is from 1.0:1 to 1.6:1.

29. The cutting insert for a modular rotary cutting tool of claim 25, comprising two of the side notches on opposite sides of the pin circumferentially spaced 180° from each other.

30. A modular rotary cutting tool comprising:
a shank having a central longitudinal axis and comprising a central pin-receiving hole and a front pocket,
a cutting insert removably installable in the front pocket of the shank comprising a pin receivable in the pin-receiving hole of the shank,
a bump-off hole extending through the side of the shank and intersecting the pin-receiving hole, and
a bump off tool inserted within the bump-off hole wherein the bump off tool contacts the pin of the cutting insert to facilitate removal of the cutting insert from the rotary cutting tool shank.

31. The modular rotary cutting tool of claim 30 wherein the bump off tool includes a cam tip having a cam surface, the cam surface contacting the rear end of the pin such that upon rotation of the bump off tool the cam surface acts against the rear end of the pin forcing the pin axially through the pin-receiving hole.

32. The modular rotary cutting tool of claim 30 wherein the bump-off tool includes a generally circular cross section.

33. The modular rotary cutting tool of claim 31 wherein the cam tip comprises a portion having a generally cylindrical outer surface and a cam surface.

34. The modular rotary cutting tool of claim 30 wherein the bump-off hole extends radially through the shank at an angle between 5° to 30° from perpendicular to the central longitudinal axis of the shank.

35. The modular rotary cutting tool of claim 30 wherein the bump-off hole extends radially perpendicular to the central longitudinal axis of the shank.

36. The modular rotary cutting tool of claim 1, wherein the cutting insert comprises a pin extending rearwardly from the head in the axial direction having a length L_{P} and a pin diameter D_{P,} the L_{P}:D_{P} ratio is greater than 3:1.

37. The modular rotary cutting tool of claim 36, wherein the L_{P}:D_{P} ratio is from 3.5:1 to 4.0:1.
